(19) United States
(12) Patent Application Publication
(10) Pub. No.: US 2016/0162639 A1
(43) Pub. Date: Jun. 9, 2016

(54) DIGITAL IMAGE ANALYSIS AND CLASSIFICATION

(71) Applicant: Bank of America Corporation, Charlotte, NC (US)

(72) Inventors: Stewart Parbery, Charlotte, NC (US); Charles Malm, Albuquerque, NM (US); Adelina Thomas, Atlanta, GA (US)

(21) Appl. No.: 14/562,102

(22) Filed: Dec. 5, 2014

(51) Int. Cl. G06F 19/00; G06Q 20/14

(52) U.S. Cl. CPC G06F 19/322; G06F 19/328; G06F 19/3425; G06Q 20/14

(57) ABSTRACT

A computing platform may receive data comprising digital images associated with a healthcare provider. Each digital image may comprise an image of at least a portion of one or more physical documents associated with the healthcare provider. The computing platform may identify a portion of the digital images corresponding to financial instruments, a portion of the digital images corresponding to explanation-of-benefits documents, and/or a portion of the digital images corresponding to other documents and may classify (e.g., in accordance with a set of classification rules associated with the healthcare provider) each digital image of the portion corresponding to the other documents into a category (e.g., a category specified by the set of classification rules associated with the healthcare provider).

### BACKGROUND

Many large organizations generate, receive, and maintain vast quantities of physical documents (e.g., records, correspondence, and the like). Modern digital-imaging technology (e.g., high-speed scanners, optical character recognition (OCR) technology, and the like) provides organizations with the ability to convert physical documents into digital images that can be indexed, searched, and manipulated. But while digital images offer many advantages over their physical counterparts, organizations that handle large quantities of physical documents continue to face challenges. Accordingly, a need exists for digital image analysis and classification.

### SUMMARY

The following presents a simplified summary in order to provide a basic understanding of some aspects of the disclosure. This summary is not an extensive overview of the disclosure. It is intended neither to identify key or critical elements of the disclosure nor to delineate the scope of the disclosure. The following summary merely presents some concepts of the disclosure in a simplified form as a prelude to the description below.

In accordance with one or more embodiments, a computing platform may receive data comprising digital images associated with a healthcare provider. Each digital image may comprise an image of at least a portion of one or more physical documents associated with the healthcare provider. For example, the physical document(s) may have been retrieved from a secure, physical drop-box (e.g., a drop-box associated with the healthcare provider) and imaged using digital-imaging technology. The computing platform may identify a portion of the digital images corresponding to financial instruments (e.g., financial instruments physically deposited in the physical drop-box), a portion of the digital images corresponding to explanation-of-benefits documents (e.g., explanation-of-benefits documents physically deposited in the physical drop-box), and/or a portion of the digital images corresponding to other documents, which may have been physically deposited in the physical drop-box, that are neither financial instruments nor explanation-of-benefits documents (e.g., patient correspondence, returned mail, attorney requests, charitable requests, government-healthcare-program documents, insurance documents that require a response from the healthcare provider, insurance documents that do not require a response from the healthcare provider, or the like). The computing platform may classify (e.g., in accordance with a set of classification rules associated with the healthcare provider) each digital image of the portion corresponding to the other documents into a category (e.g., a category specified by the set of classification rules associated with the healthcare provider).

In some embodiments, the computing platform may generate data (e.g., data for one or more graphical user interfaces) configured to provide the healthcare provider with access to each of the digital images corresponding to the other documents and comprising one or more elements distinguishing (e.g., via the graphical user interface(s)) each of the digital images classified into a particular category from digital images classified into a category different from the particular category. The computing platform may communicate (e.g., via one or more networks) such data to a computing device associated with the healthcare provider.

In some embodiments, the computing platform may receive (e.g., from the computing device associated with the healthcare provider) data indicating that one or more digital images have been reclassified by the healthcare provider (e.g., via the graphical user interface(s)) into a different category and may update, based on such data, the set of classification rules associated with the healthcare provider. In such embodiments, updating the set of classification rules may include identifying one or more features of the reclassified digital image(s) indicating that the digital image(s) should be classified into the different category and modifying the set of classification rules to classify subsequently received digital images having the feature(s) into the different category. In some embodiments, the computing platform may receive (e.g., from the computing device associated with the healthcare provider) data identifying the feature(s). Additionally or alternatively, the computing platform may analyze the reclassified digital image(s) to identify the feature(s), for example, by comparing the reclassified digital image(s) to one or more digital images classified into the category into which the reclassified digital image(s) were previously classified (e.g., digital image(s) that were classified into the same category into which the reclassified digital image(s) were previously classified but were not reclassified into the different category) and/or one or more digital images previously classified by the computing platform into the different category.

In some embodiments, the computing platform may receive data comprising additional digital images associated with the healthcare provider. The additional digital images may include at least one digital image comprising an image of at least a portion of one or more physical documents having the feature(s) (e.g., one or more physical documents subsequently retrieved from the physical drop-box that have the feature(s)), and the computing platform may classify, based on the set of classification rules (e.g., the updated set of classification rules) and identification by the computing platform of the feature(s) in the at least one digital image, the at least one digital image into the different category. In such embodiments, the computing platform may generate data (e.g., data for one or more graphical user interfaces) configured to provide the healthcare provider with access to the previously received digital images, as well as the additional digital images, including the at least one digital image, and may communicate (e.g., via one or more networks) such data to the computing device associated with the healthcare provider. In some embodiments, such data may be configured to indicate (e.g., via the graphical user interface(s)) that the physical document(s) subsequently retrieved from the physical drop-box were retrieved at a later time than a time at which the previously retrieved physical document(s) were retrieved from the physical drop-box.

In some embodiments, the computing platform may analyze each digital image of the portion corresponding to the financial instruments to identify, in data comprising the digital image, information identifying a patient of the healthcare provider, a transaction of the patient with the healthcare provider, a payment amount for the transaction of the patient with the healthcare provider, and/or a source of funds for the payment amount. In such embodiments, the computing platform may credit an account of the healthcare provider with the payment amount and/or transfer the payment amount from an account of a financial institution associated with the source of funds to an account of a financial institution associated with the healthcare provider. Additionally or alternatively, the computing platform may generate data (e.g., data for one or more graphical user interfaces) configured to provide the healthcare provider with information identifying the patient, the transaction, the payment amount, and/or the source of funds and may communicate (e.g., via one or more networks) such data to a computing device associated with the healthcare provider.

In some embodiments, the computing platform may analyze each digital image of the portion corresponding to the explanation-of-benefits documents to identify, in data comprising the digital image, information identifying a patient of the healthcare provider, a transaction of the patient with the healthcare provider, an insurance policy covering at least a portion of one or more expenditures of the healthcare provider associated with the transaction, and/or one or more amounts of the expenditure(s) covered by the insurance policy. In such embodiments, the computing platform may generate data (e.g., data for one or more graphical user interfaces) configured to provide the healthcare provider with information identifying the patient, the transaction, the insurance policy, and/or the amount(s) covered by the insurance policy and may communicate (e.g., via one or more networks) such data to a computing device associated with the healthcare provider.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for digital image analysis and classification in accordance with one or more example embodiments;

FIG. 4A, FIG. 4B, FIG. 4C, and FIG. 4D depict an illustrative event sequence for digital image analysis and classification in accordance with one or more example embodiments;

FIG. 5 depicts an illustrative graphical user interface for digital image analysis and classification in accordance with one or more example embodiments; and

FIG. 6 depicts multiple illustrative methods for digital image analysis and classification in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

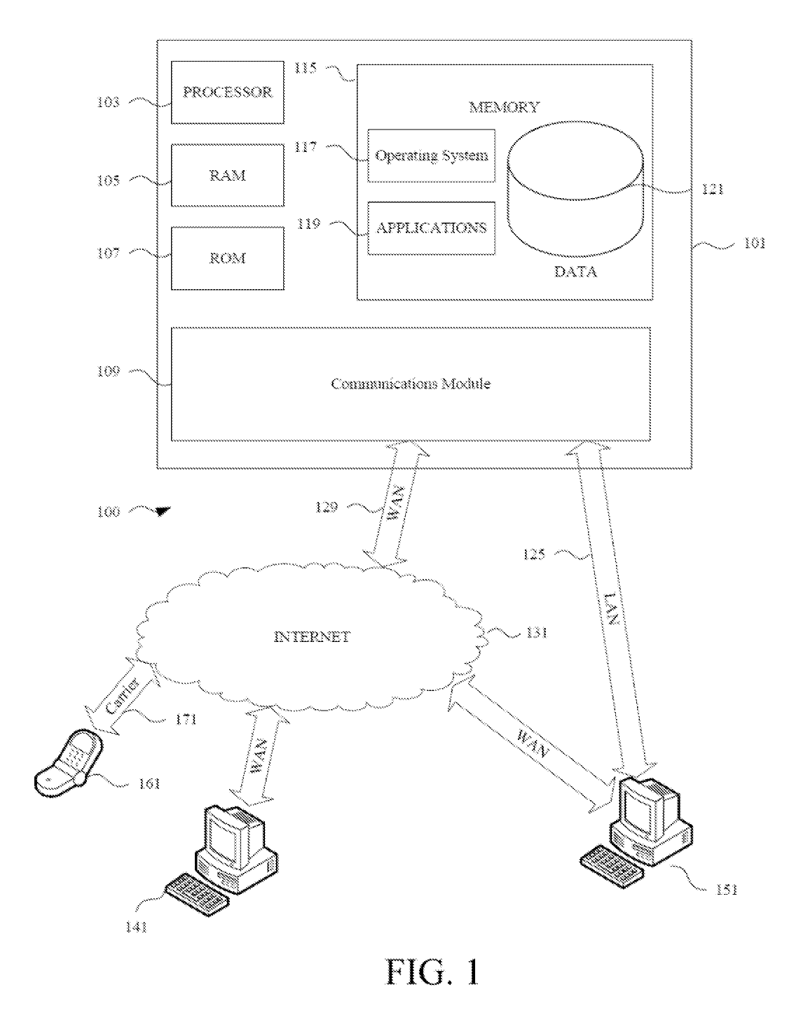

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

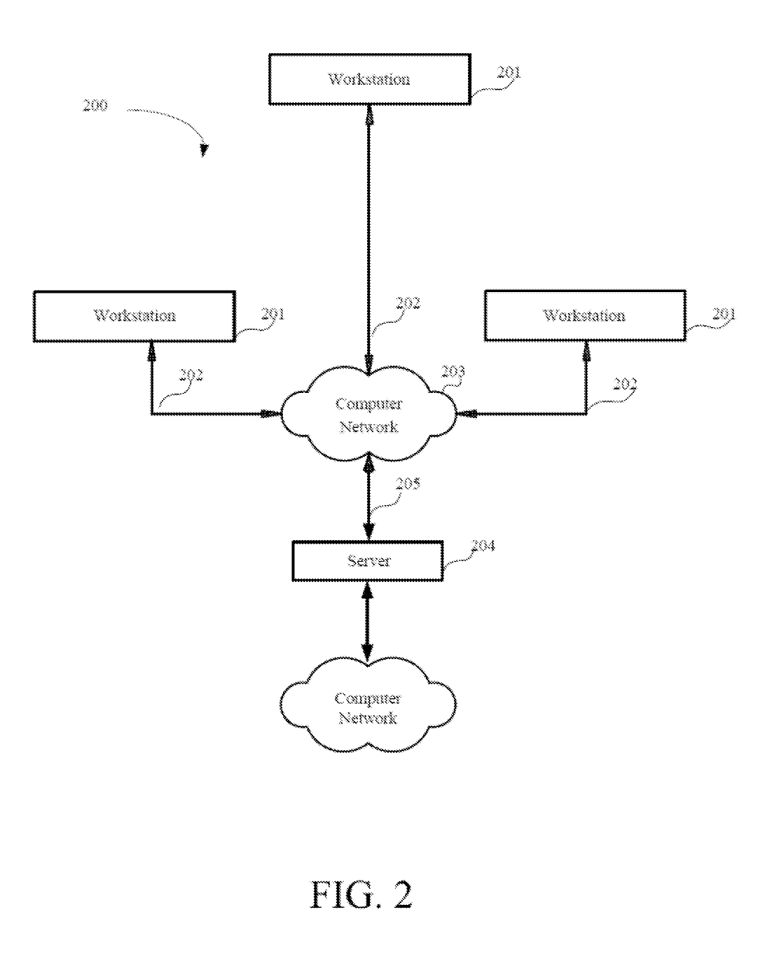

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

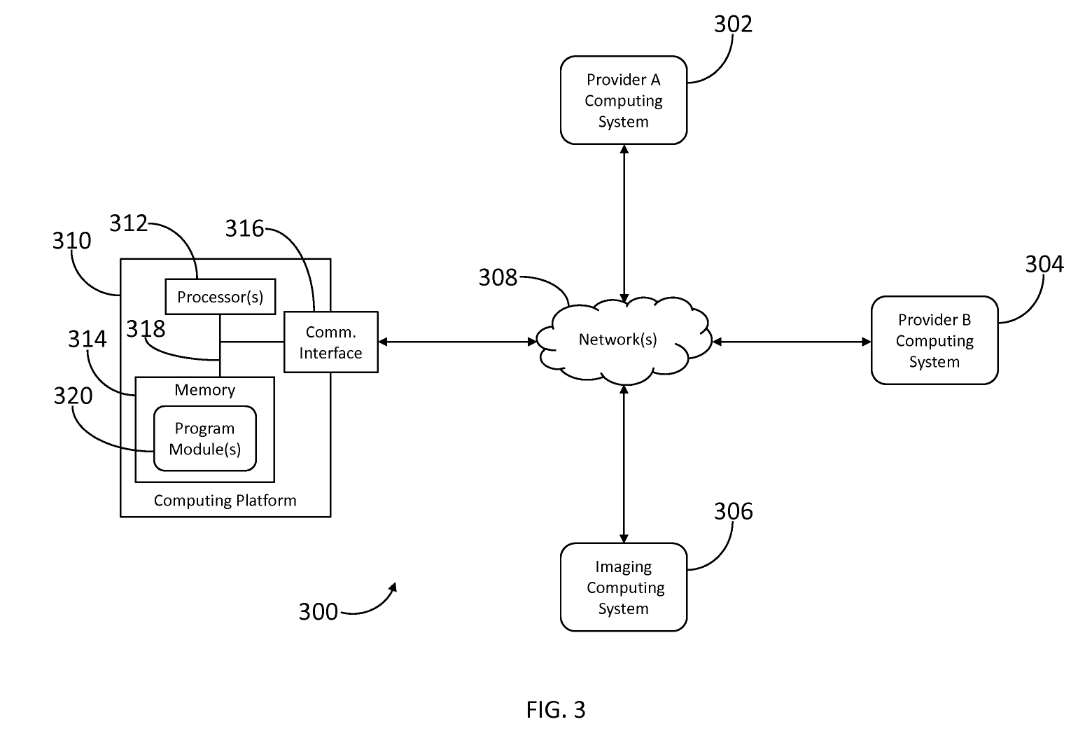

FIG. 3 depicts an illustrative computing environment for digital image analysis and classification in accordance with one or more example embodiments. Referring to FIG. 3, computing environment 300 may be associated with one or more organizations (e.g., corporations, universities, government entities, healthcare providers, financial institutions, or the like) and may include one or more computing systems. For example, computing environment 300 may include provider computing system 302 (e.g., associated with healthcare provider A), provider computing system 304 (e.g., associated with healthcare provider B), and imaging computing system 306 (e.g., associated with healthcare provider A, healthcare provider B, and/or an organization that provides one or more services to healthcare provider A and/or healthcare provider B). Provider computing system 302, provider computing system 304, and/or imaging computing system 306 may include one or more of any type of computing device (e.g., imaging system, scanner, digital camera, desktop computer, laptop computer, tablet computer, smart phone, server, server blade, mainframe, virtual machine, or the like) configured to perform one or more of the functions described herein. Computing environment 300 may also include one or more networks. For example, computing environment 300 may include network(s) 308, which may include one or more sub-networks (e.g., LANs, WANs, VPNs, or the like) and may interconnect one or more of provider computing system 302, provider computing system 304, and imaging computing system 306.

Computing environment 300 may also include one or more computing platforms. For example, computing environment 300 may include computing platform 310. Computing platform 310 may include one or more of any type of computing device (e.g., desktop computer, laptop computer, tablet computer, smart phone, server, server blade, mainframe, virtual machine, or the like) configured to perform one or more of the functions described herein. In some embodiments, computing platform 310 may include one or more of provider computing system 302, provider computing system 304, or imaging computing system 306. Computing platform 310 may include one or more processor(s) 312, memory 314, communication interface 316, and/or data bus 318. Data bus 318 may interconnect processor(s) 312, memory 314, and/or communication interface 316. Communication interface 316 may be a network interface configured to support communication between computing platform 310 and network(s) 308 (or one or more sub-networks thereof). Memory 314 may include one or more program modules comprising instructions that when executed by processor(s) 312 cause computing platform 310 to perform one or more functions described herein. For example, memory 314 may include program module(s) 320, which may comprise instructions that when executed by processor(s) 312 cause computing platform 310 to perform one or more functions described herein.

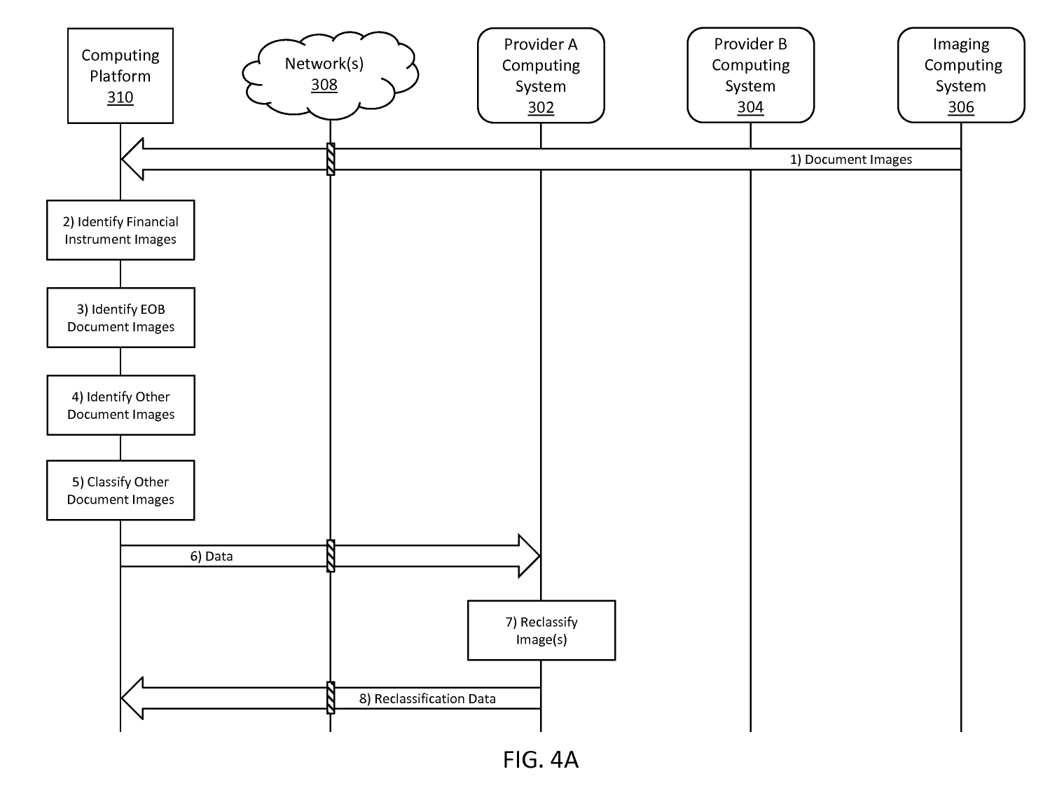

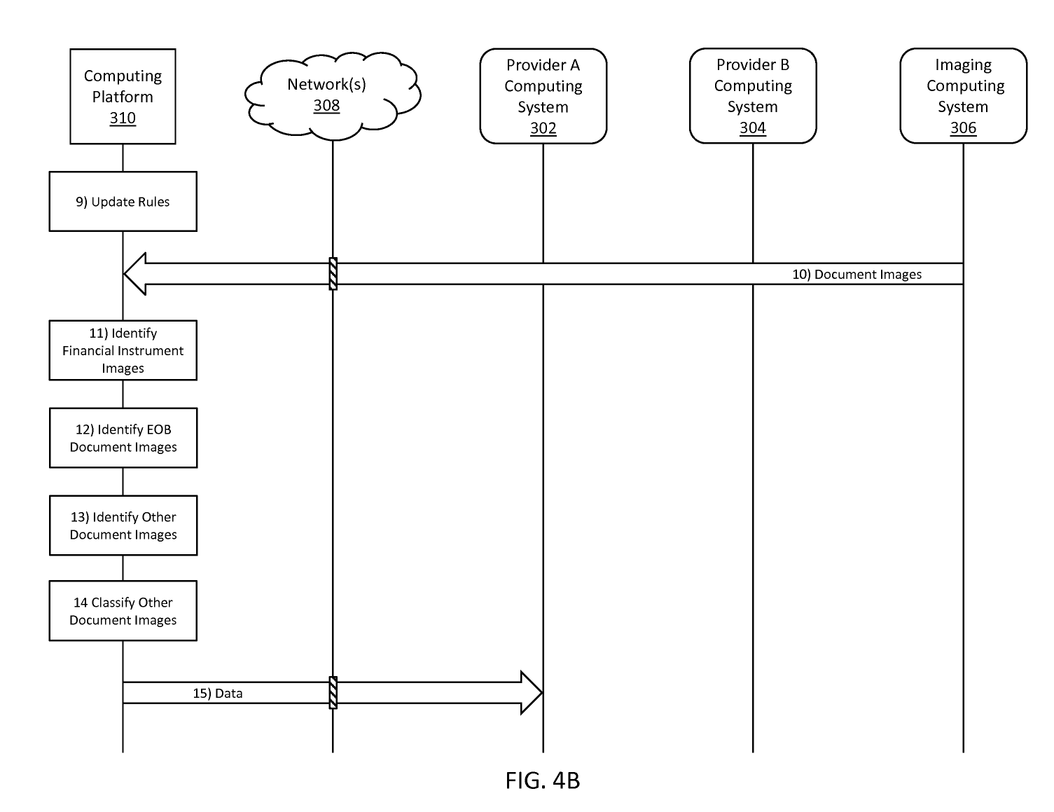

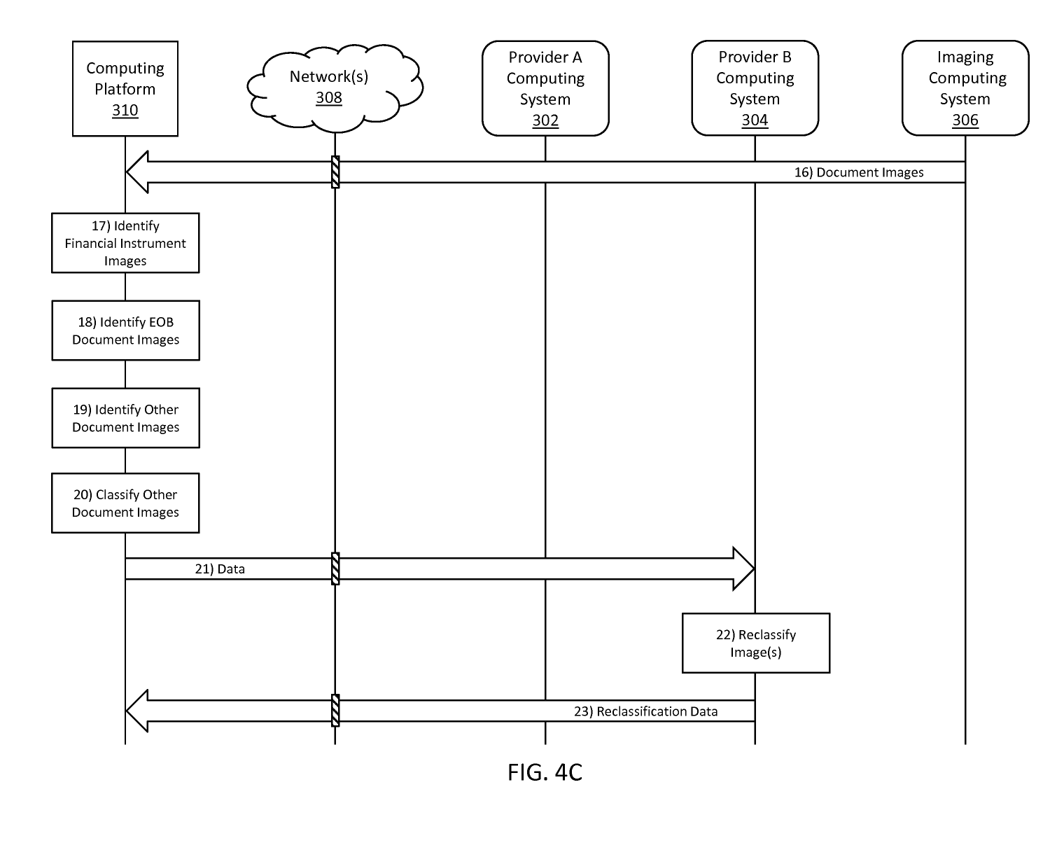

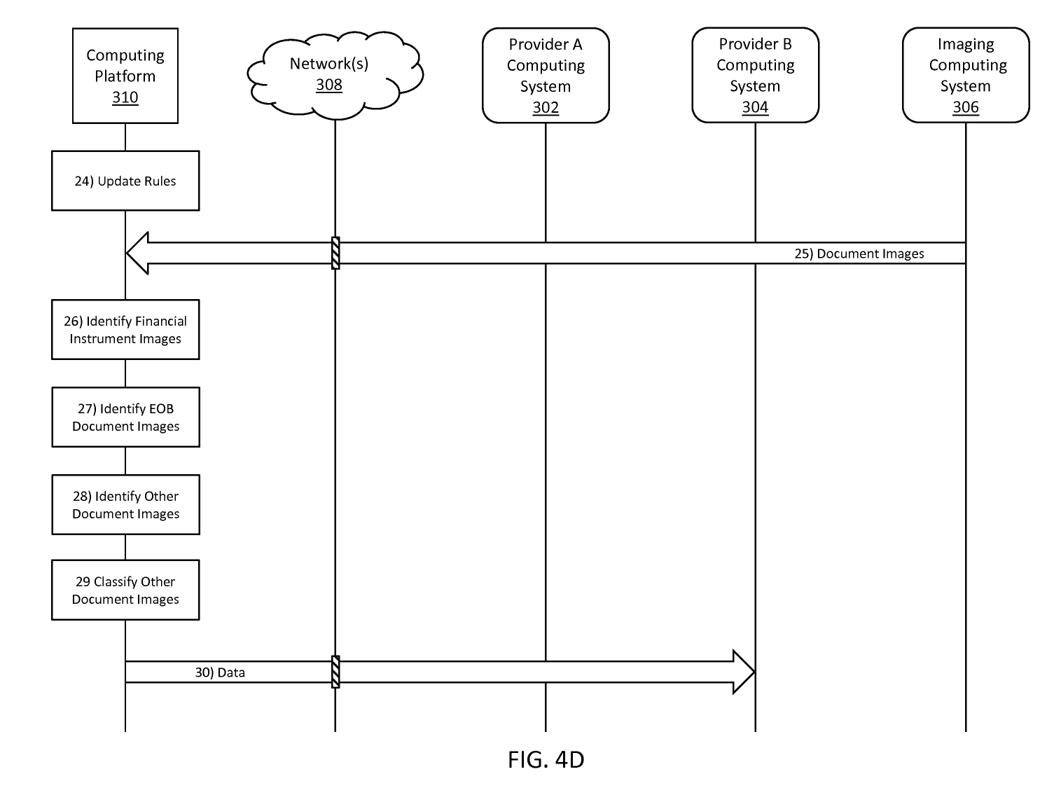

FIG. 4A, FIG. 4B, FIG. 4C, and FIG. 4D depict an illustrative event sequence for digital image analysis and classification in accordance with one or more example embodiments. Referring to FIG. 4A, at step 1, computing platform 310 may receive (e.g., via communication interface 316 and/or network(s) 308) data comprising digital images associated with a healthcare provider (e.g., healthcare provider A) from imaging computing system 306. Each digital image may comprise an image of at least a portion of one or more physical documents associated with the healthcare provider. For example, the physical document(s) may have been retrieved from a secure, physical drop-box (e.g., a drop-box associated with the healthcare provider) and imaged using digital-imaging technology. At step 2, computing platform 310 may identify a portion of the digital images corresponding to financial instruments (e.g., financial instruments physically deposited in the physical drop-box). In some embodiments, computing platform 310 may analyze each digital image of the portion corresponding to the financial instruments to identify, in data comprising the digital image, information identifying a patient of the healthcare provider, a transaction of the patient with the healthcare provider, a payment amount for the transaction of the patient with the healthcare provider, and/or a source of funds for the payment amount. In such embodiments, computing platform 310 may credit an account of the healthcare provider with the payment amount and/or transfer the payment amount from an account of a financial institution associated with the source of funds to an account of a financial institution associated with the healthcare provider. Additionally or alternatively, computing platform 310 may generate data (e.g., data for one or more graphical user interfaces) configured to provide the healthcare provider with information identifying the patient, the transaction, the payment amount, and/or the source of funds.

At step 3, computing platform 310 may identify a portion of the digital images corresponding to explanation-of-benefits documents (e.g., explanation-of-benefits documents physically deposited in the physical drop-box). In some embodiments, computing platform 310 may analyze each digital image of the portion corresponding to the explanation-of-benefits documents to identify, in data comprising the digital image, information identifying a patient of the healthcare provider, a transaction of the patient with the healthcare provider, an insurance policy covering at least a portion of one or more expenditures of the healthcare provider associated with the transaction, and/or one or more amounts of the expenditure(s) covered by the insurance policy. In such embodiments, computing platform 310 may generate data (e.g., data for one or more graphical user interfaces) configured to provide the healthcare provider with information identifying the patient, the transaction, the insurance policy, and/or the amount(s) covered by the insurance policy. At step 4, computing platform 310 may identify a portion of the digital images corresponding to other documents, which may have been physically deposited in the physical drop-box, that are neither financial instruments nor explanation-of-benefits documents (e.g., patient correspondence, returned mail, attorney requests, charitable requests, government-healthcare-program documents, insurance documents that require a response from the healthcare provider, insurance documents that do not require a response from the healthcare provider, or the like).

At step 5, computing platform 310 may classify, for example, in accordance with a set of classification rules stored in memory 314 (e.g., classification rules associated with healthcare provider A) each digital image of the portion corresponding to the other documents into a category (e.g., a category specified by the set of classification rules). For example, the set of classification rules may specify multiple different categories defined by the healthcare provider (e.g., a category for patient correspondence, a category for returned mail, a category for attorney requests, a category for charitable requests, a category for government-healthcare-program documents, a category for insurance documents that require a response from the healthcare provider, a category for insurance documents that do not require a response from the healthcare provider, or the like), and computing platform 310 may classify each digital image of the portion corresponding to the other documents into a category of the multiple different categories defined by the healthcare provider. In some embodiments, computing platform 310 may generate data (e.g., data for one or more graphical user interfaces) configured to provide the healthcare provider with access to each of the digital images corresponding to the other documents and comprising one or more elements distinguishing (e.g., via the graphical user interface(s)) each of the digital images classified into a particular category from digital images classified into a category different from the particular category. At step 6, computing platform 310 may communicate (e.g., via communication interface 316 and/or network(s) 308) data configured to provide the healthcare provider with access to one or more of the digital images (e.g., one or more of the portion of the digital images corresponding to financial instruments, the portion of the digital images corresponding to explanation-of-benefits documents, and/or the portion of the digital images corresponding to other documents) and/or configured to provide the healthcare provider with information associated with one or more of the digital images (e.g., data previously generated by computing platform 310, as described above with respect to steps 2, 3, 4, and 5) to provider computing system 302.

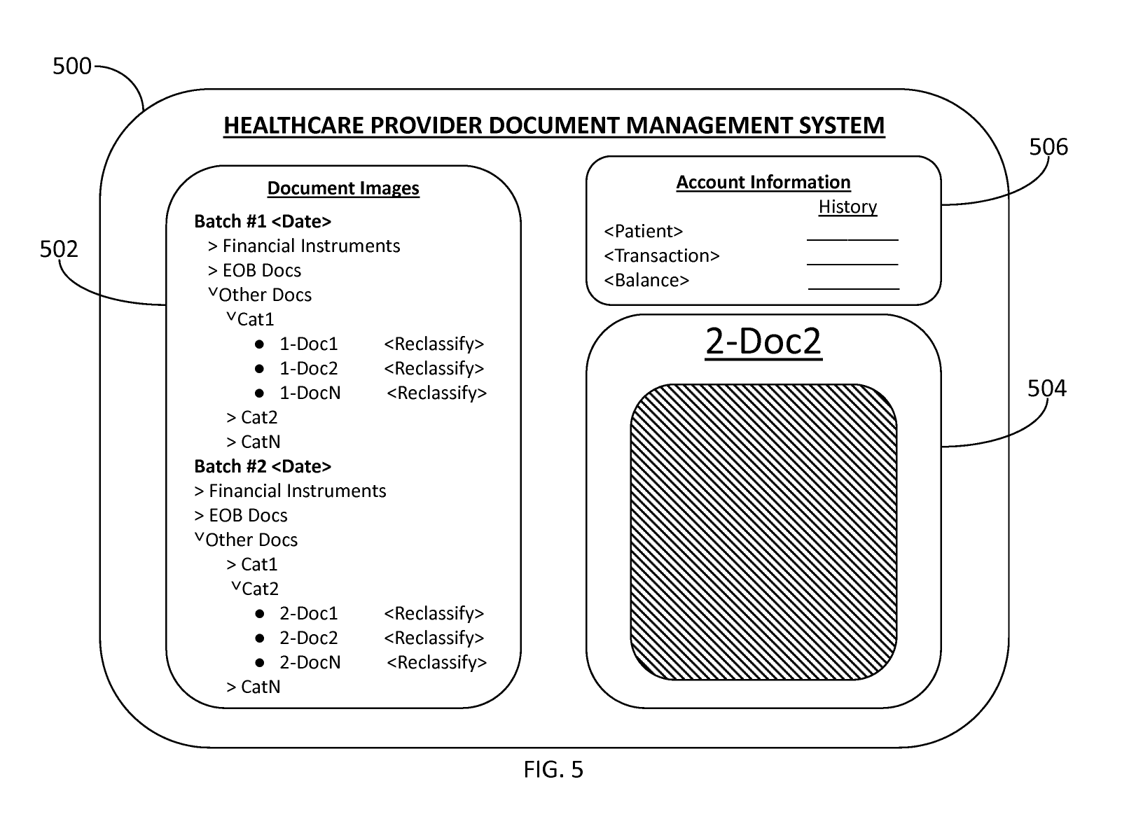

Provider computing system 302 may receive the data from computing platform 310 and may generate (e.g., based on the data (or a portion thereof) one or more graphical user interfaces for display by provider computing system 302. For example, referring to FIG. 5, provider computing system 302 may generate one or more graphical user interfaces similar to interface 500. Interface 500 may include listing element 502, which may include a listing of available digital images (or a portion thereof). Interface 500 may visually distinguish the available digital images based on, for example: an associated batch identifier, and/or date/time when the corresponding physical documents were retrieved from the drop-box and/or imaged; their respective grouping (e.g., whether they are amongst the portion of the digital images corresponding to financial instruments, the portion of the digital images corresponding to explanation-of-benefits documents, and/or the portion of the digital images corresponding to other documents); and/or a category into which they have been classified. Interface 500 may include viewing element 504 and/or associated data element 506. Viewing element 504 may display one or more digital images (or portions thereof) selected from the listing, and associated data element 506 may display data associated with the displayed digital image(s) (e.g., data previously generated by computing platform 310, as described above with respect to steps 2, 3, 4, and 5).

Interface 500 may also include one or more elements for reclassifying one or more of the digital images into a different category and/or identifying one or more features of the reclassified digital image(s) indicating that the digital image(s) should be classified into the different category. Returning to FIG. 4A, at step 7, a user of provider computing system 302 may utilize such element(s) to reclassify one or more of the digital images into a different category and/or identify one or more features of the reclassified digital image(s) indicating that the digital image(s) should be classified into the different category. At step 8, computing platform 310 may receive (e.g., via communication interface 316 and/or network(s) 308) data, from provider computing system 302, indicating that digital image(s) have been reclassified by the healthcare provider into the different category and/or the feature(s) of the reclassified digital image(s) indicating that the digital image(s) should be classified into the different category. Referring to FIG. 4B, at step 9, computing platform 310 may update, based on such data, the set of classification rules associated with the healthcare provider. Updating the set of classification rules may include identifying one or more features of the reclassified digital image(s) indicating that the digital image(s) should be classified into the different category and modifying the set of classification rules to classify subsequently received digital images having the feature(s) into the different category. In some embodiments, computing platform 310 may identify the feature(s) (or a portion thereof) of the reclassified digital image(s) indicating that the digital image(s) should be classified into the different category based on the data received from provider computing system 302. Additionally or alternatively, computing platform 310 may analyze the reclassified digital image(s) to identify the feature(s) (or a portion thereof) of the reclassified digital image(s) indicating that the digital image(s) should be classified into the different category, for example, by comparing the reclassified digital image(s) to one or more digital images classified into the category into which the reclassified digital image(s) were previously classified (e.g., digital image(s) that were classified into the same category into which the reclassified digital image(s) were previously classified but were not reclassified into the different category) and/or one or more digital images previously classified by computing platform 310 into the different category.

At step 10, computing platform 310 may receive (e.g., via communication interface 316 and/or network(s) 308) data comprising additional digital images associated with the healthcare provider from imaging computing system 306. Each of the additional digital images may comprise an image of at least a portion of one or more physical documents associated with the healthcare provider, for example, physical document(s) that may have been retrieved from the drop-box at a later time than a time at which the previously retrieved physical document(s) (e.g., the physical documents described above with respect to step 1) were retrieved from the drop-box. The additional digital images may include at least one digital image comprising an image of at least a portion of one or more physical documents having the feature(s). At step 11, computing platform 310 may identify a portion of the additional digital images corresponding to financial instruments. At step 12, computing platform 310 may identify a portion of the additional digital images corresponding to explanation-of-benefits documents. At step 13, computing platform 310 may identify a portion of the additional digital images corresponding to other documents that are neither financial instruments nor explanation-of-benefits documents. At step 14, computing platform 310 may classify, for example, in accordance with the updated set of classification rules each digital image of the portion corresponding to the other documents into a category (e.g., a category specified by the updated set of classification rules). Computing platform 310 may identify the feature(s) in the at least one digital image and may classify, based on the updated set of classification rules and identification of the feature(s) in the at least one digital image, the at least one digital image into the different category. At step 15, computing platform 310 may communicate (e.g., via communication interface 316 and/or network(s) 308), to provider computing system 302, data configured to provide the healthcare provider with access to one or more of the additional digital images. In some embodiments, such data may be configured to indicate (e.g., via the graphical user interface(s)) that the additional digital images correspond to the physical documents retrieved from the drop-box at the later time.

Referring to FIG. 4C, at step 16, computing platform 310 may receive (e.g., via communication interface 316 and/or network(s) 308) data comprising digital images associated with a different healthcare provider (e.g., healthcare provider B) from imaging computing system 306. Each digital image may comprise an image of at least a portion of one or more physical documents associated with the different healthcare provider. For example, the physical document(s) may have been retrieved from a secure, physical drop-box (e.g., a drop-box associated with the different healthcare provider) and imaged using digital-imaging technology. At step 17, computing platform 310 may identify a portion of the digital images corresponding to financial instruments (e.g., financial instruments physically deposited in the physical drop-box). In some embodiments, computing platform 310 may analyze each digital image of the portion corresponding to the financial instruments to identify, in data comprising the digital image, information identifying a patient of the different healthcare provider, a transaction of the patient with the different healthcare provider, a payment amount for the transaction of the patient with the different healthcare provider, and/or a source of funds for the payment amount. In such embodiments, computing platform 310 may credit an account of the different healthcare provider with the payment amount and/or transfer the payment amount from an account of a financial institution associated with the source of funds to an account of a financial institution associated with the different healthcare provider. Additionally or alternatively, computing platform 310 may generate data (e.g., data for one or more graphical user interfaces) configured to provide the different healthcare provider with information identifying the patient, the transaction, the payment amount, and/or the source of funds.

At step 18, computing platform 310 may identify a portion of the digital images corresponding to explanation-of-benefits documents (e.g., explanation-of-benefits documents physically deposited in the physical drop-box). In some embodiments, computing platform 310 may analyze each digital image of the portion corresponding to the explanation-of-benefits documents to identify, in data comprising the digital image, information identifying a patient of the different healthcare provider, a transaction of the patient with the different healthcare provider, an insurance policy covering at least a portion of one or more expenditures of the different healthcare provider associated with the transaction, and/or one or more amounts of the expenditure(s) covered by the insurance policy. In such embodiments, computing platform 310 may generate data (e.g., data for one or more graphical user interfaces) configured to provide the different healthcare provider with information identifying the patient, the transaction, the insurance policy, and/or the amount(s) covered by the insurance policy. At step 19, computing platform 310 may identify a portion of the digital images corresponding to other documents, which may have been physically deposited in the physical drop-box, that are neither financial instruments nor explanation-of-benefits documents (e.g., patient correspondence, returned mail, attorney requests, charitable requests, government-healthcare-program documents, insurance documents that require a response from the different healthcare provider, insurance documents that do not require a response from the different healthcare provider, or the like).

At step 20, computing platform 310 may classify, for example, in accordance with a set of classification rules stored in memory 314 (e.g., classification rules associated with healthcare provider B) each digital image of the portion corresponding to the other documents into a category (e.g., a category specified by the set of classification rules). For example, the set of classification rules may specify multiple different categories defined by the different healthcare provider (e.g., a category for patient correspondence, a category for returned mail, a category for attorney requests, a category for charitable requests, a category for government-healthcare-program documents, a category for insurance documents that require a response from the different healthcare provider, a category for insurance documents that do not require a response from the different healthcare provider, or the like), and computing platform 310 may classify each digital image of the portion corresponding to the other documents into a category of the multiple different categories defined by the different healthcare provider. In some embodiments, computing platform 310 may generate data (e.g., data for one or more graphical user interfaces) configured to provide the different healthcare provider with access to each of the digital images corresponding to the other documents and comprising one or more elements distinguishing (e.g., via the graphical user interface(s)) each of the digital images classified into a particular category from digital images classified into a category different from the particular category. At step 21, computing platform 310 may communicate (e.g., via communication interface 316 and/or network(s) 308) data configured to provide the different healthcare provider with access to one or more of the digital images (e.g., one or more of the portion of the digital images corresponding to financial instruments, the portion of the digital images corresponding to explanation-of-benefits documents, and/or the portion of the digital images corresponding to other documents) and/or configured to provide the different healthcare provider with information associated with one or more of the digital images (e.g., data previously generated by computing platform 310, as described above with respect to steps 17, 18, 19, and 20) to provider computing system 304.

Provider computing system 304 may receive the data from computing platform 310 and may generate (e.g., based on the data (or a portion thereof) one or more graphical user interfaces for display by provider computing system 304. For example, provider computing system 304 may generate one or more graphical user interfaces similar to interface 500. As indicated above, interface 500 may include one or more elements for reclassifying one or more of the digital images into a different category and/or identifying one or more features of the reclassified digital image(s) indicating that the digital image(s) should be classified into the different category. At step 22, a user of provider computing system 304 may utilize such element(s) to reclassify one or more of the digital images into a different category and/or identify one or more features of the reclassified digital image(s) indicating that the digital image(s) should be classified into the different category. At step 23, computing platform 310 may receive (e.g., via communication interface 316 and/or network(s) 308) data, from provider computing system 304, indicating that digital image(s) have been reclassified by the different healthcare provider into the different category and/or the feature(s) of the reclassified digital image(s) indicating that the digital image(s) should be classified into the different category. Referring to FIG. 4D, at step 24, computing platform 310 may update, based on such data, the set of classification rules associated with the different healthcare provider. Updating the set of classification rules may include identifying one or more features of the reclassified digital image(s) indicating that the digital image(s) should be classified into the different category and modifying the set of classification rules to classify subsequently received digital images having the feature(s) into the different category. In some embodiments, computing platform 310 may identify the feature(s) (or a portion thereof) of the reclassified digital image(s) indicating that the digital image(s) should be classified into the different category based on the data received from provider computing system 304. Additionally or alternatively, computing platform 310 may analyze the reclassified digital image(s) to identify the feature(s) (or a portion thereof) of the reclassified digital image(s) indicating that the digital image(s) should be classified into the different category, for example, by comparing the reclassified digital image(s) to one or more digital images classified into the category into which the reclassified digital image(s) were previously classified (e.g., digital image(s) that were classified into the same category into which the reclassified digital image(s) were previously classified but were not reclassified into the different category) and/or one or more digital images previously classified by computing platform 310 into the different category.

At step 25, computing platform 310 may receive (e.g., via communication interface 316 and/or network(s) 308) data comprising additional digital images associated with the different healthcare provider from imaging computing system 306. Each of the additional digital images may comprise an image of at least a portion of one or more physical documents associated with the different healthcare provider, for example, physical document(s) that may have been retrieved from the drop-box at a later time than a time at which the previously retrieved physical document(s) (e.g., the physical documents described above with respect to step 16) were retrieved from the drop-box. The additional digital images may include at least one digital image comprising an image of at least a portion of one or more physical documents having the feature(s). At step 26, computing platform 310 may identify a portion of the additional digital images corresponding to financial instruments. At step 27, computing platform 310 may identify a portion of the additional digital images corresponding to explanation-of-benefits documents. At step 28, computing platform 310 may identify a portion of the additional digital images corresponding to other documents that are neither financial instruments nor explanation-of-benefits documents. At step 29, computing platform 310 may classify, for example, in accordance with the updated set of classification rules each digital image of the portion corresponding to the other documents into a category (e.g., a category specified by the updated set of classification rules). Computing platform 310 may identify the feature(s) in the at least one digital image and may classify, based on the updated set of classification rules and identification of the feature(s) in the at least one digital image, the at least one digital image into the different category. At step 30, computing platform 310 may communicate (e.g., via communication interface 316 and/or network(s) 308), to provider computing system 304, data configured to provide the different healthcare provider with access to one or more of the additional digital images. In some embodiments, such data may be configured to indicate (e.g., via the graphical user interface(s)) that the additional digital images correspond to the physical documents retrieved from the drop-box at the later time.

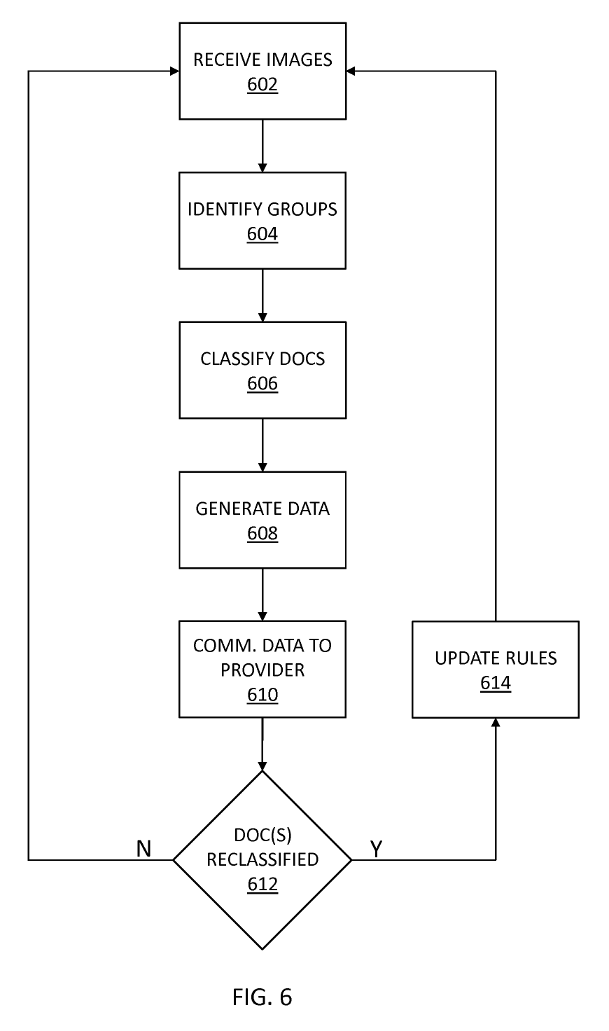

FIG. 6 depicts multiple illustrative methods for digital image analysis and classification in accordance with one or more example embodiments. Referring to FIG. 6, at step 602, data comprising digital images associated with a healthcare provider may be received. For example, computing platform 310 may receive data comprising digital images associated with healthcare provider A from imaging computing system 306. At step 604, one or more groups of the digital images may be identified. For example, computing platform 310 may identify a group comprising a portion of the digital images corresponding to financial instruments, a group comprising a portion of the digital images corresponding to explanation-of-benefits documents, and/or a group comprising a portion of the digital images corresponding to other documents. At step 606, one or more digital images may be classified into a category. For example, computing platform 310 may classify each digital image in the group comprising the portion corresponding to the other documents into a category specified by a set of classification rules associated with healthcare provider A. At step 608, data (e.g., data for one or more graphical user interfaces) configured to provide the healthcare provider with access to one or more of the digital images may be generated. For example, computing platform 310 may generate data (e.g., data for graphical user interface 500) configured to provide healthcare provider A with access to one or more of the digital images. At step 610, the data may be communicated to the healthcare provider. For example, computing platform 310 may communicate, to provider computing system 302, the data configured to provide healthcare provider A with access to one or more of the digital images.

At step 612, a determination may be made as to whether the healthcare provider has reclassified one or more of the digital images. For example, computing platform 310 may determine that healthcare provider A has not reclassified any of the digital images classified in step 606 into a different category than the category into which the digital images were classified in step 606. Responsive to a determination that the healthcare provider has not reclassified any of the digital images classified in step 606, the method may return to step 602 to await receipt of data comprising additional digital images associated with the healthcare provider. Returning to step 612, responsive to a determination that the healthcare provider has reclassified one or more of the digital images classified in step 606 into a different category than the category into which the digital image(s) were classified in step 606, at step 614, a set of classification rules associated with the healthcare provider may be updated, and the method may return to step 602 to await receipt of data comprising additional digital images associated with the healthcare provider. For example, computing platform 310 may determine that healthcare provider A has reclassified one or more of the digital images into a different category than the category into which the digital image(s) were classified in step 606, computing platform 310 may update the set of classification rules associated with healthcare provider A, and may await receipt of data comprising additional digital images associated with healthcare provider A.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
at a computing platform comprising at least one processor, a communication interface, and a memory:
receiving, via the communication interface, data comprising a plurality of digital images associated with a healthcare provider, each digital image of the plurality of digital images comprising an image of at least a portion of one or more physical documents of a plurality of physical documents associated with the healthcare provider and retrieved from a secure, physical drop-box associated with the healthcare provider;
identifying, by the at least one processor, a portion of the plurality of digital images corresponding to financial instruments physically deposited in the physical drop-box;
identifying, by the at least one processor, a portion of the plurality of digital images corresponding to explanation-of-benefits documents physically deposited in the physical drop-box;
identifying, by the at least one processor, a portion of the plurality of digital images corresponding to other documents physically deposited in the physical drop-box, the other documents comprising neither the financial instruments nor the explanation-of-benefits documents;
classifying, by the at least one processor and in accordance with a set of classification rules associated with the healthcare provider and stored in the memory, each digital image of the portion of the plurality of digital images corresponding to the other documents into a category of a plurality of different categories specified by the set of classification rules;
generating, by the at least one processor, data for one or more graphical user interfaces configured to provide the healthcare provider with access to each digital image of the portion of the plurality of digital images corresponding to the other documents and comprising one or more elements distinguishing each digital image of the portion of the plurality of digital images corresponding to the other documents classified into a particular category of the plurality of different categories from each other digital image of the portion of the plurality of digital images corresponding to the other documents classified into a category of the plurality of different categories different from the particular category; and
communicating, via the communication interface and to a computing device associated with the healthcare provider, the data for the one or more graphical user interfaces.

2. The method of claim 1, comprising:
receiving, via the communication interface and from the computing device associated with the healthcare provider, data indicating that one or more digital images of the portion of the plurality of digital images corresponding to the other documents classified into a first category of the plurality of different categories have been reclassified by the healthcare provider via the one or more graphical user interfaces into a second category of the plurality of different categories, the second category being different from the first category; and
updating, by the at least one processor and based on the data indicating that the one or more digital images of the portion of the plurality of digital images corresponding to the other documents classified in the first category of the plurality of different categories have been reclassified by the healthcare provider, the set of classification rules associated with the healthcare provider.

3. The method of claim 2, wherein updating the set of classification rules comprises:
identifying one or more features of the one or more digital images indicating that the one or more digital images should be classified into the second category; and
modifying the set of classification rules to classify subsequently received digital images having the one or more features into the second category.

4. The method of claim 3, comprising receiving, via the communication interface and from the computing device associated with the healthcare provider, data identifying the one or more features.

5. The method of claim 3, comprising analyzing, by the at least one processor, the one or more digital images to identify the one or more features.

6. The method of claim 5, wherein analyzing the one or more digital images comprises comparing the one or more digital images to at least one digital image of the portion of the plurality of digital images corresponding to the other documents previously classified by the at least one processor into the first category and at least one digital image of the portion of the plurality of digital images corresponding to the other documents previously classified by the at least one processor into the second category.

7. The method of claim 3, comprising:
receiving, via the communication interface, data comprising a second plurality of digital images associated with the healthcare provider, the second plurality of digital images comprising at least one digital image comprising an image of at least a portion of one or more physical documents having the one or more features; and
classifying, by the at least one processor and based on the set of classification rules and identification by the at least one processor of the one or more features in the at least one digital image, the at least one digital image into the second category.

8. The method of claim 7, wherein the plurality of physical documents associated with the healthcare provider were retrieved from the physical drop-box at a first time, wherein the one or more physical documents having the one or more features were retrieved from the physical drop-box at a second time, the second time being a time subsequent in time to the first time, the method comprising:
generating, by the at least one processor, data for at least one graphical user interface configured to: provide the healthcare provider with access to digital images of each of the plurality of physical documents and digital images of each of the one or more physical documents having the one or more features; and indicate that the plurality of physical documents associated with the healthcare provider were retrieved from the physical drop-box at the first time and the one or more physical documents having the one or more features were retrieved from the physical drop-box at the second time; and
communicating, via the communication interface and to the computing device associated with the healthcare provider, the data for the at least one graphical user interface.

9. The method of claim 1, comprising for each digital image of the portion of the plurality of digital images corresponding to the financial instruments, analyzing, by the at least one processor, data comprising the digital image to identify, in the data comprising the digital image, information identifying a patient of the healthcare provider, a transaction of the patient with the healthcare provider, a payment amount for the transaction of the patient with the healthcare provider, and a source of funds for the payment amount.

10. The method of claim 9, comprising for each digital image of the portion of the plurality of digital images corresponding to the financial instruments, crediting, by the at least one processor, an account of the healthcare provider with the payment amount for the transaction of the patient with the healthcare provider.

11. The method of claim 9, comprising for each digital image of the portion of the plurality of digital images corresponding to the financial instruments, transferring, by the at least one processor, from an account of a financial institution associated with the source of funds, and to an account of a financial institution associated with the healthcare provider, the payment amount for the transaction of the patient with the healthcare provider.

12. The method of claim 9, wherein generating the data for the one or more graphical user interfaces comprises generating data for one or more graphical user interfaces configured to provide, for each digital image of the portion of the plurality of digital images corresponding to the financial instruments, the healthcare provider with the information identifying the patient of the healthcare provider, the transaction of the patient with the healthcare provider, and the payment amount for the transaction of the patient with the healthcare provider.

13. The method of claim 1, comprising for each digital image of the portion of the plurality of digital images corresponding to the explanation-of-benefits documents, analyzing, by the at least one processor, data comprising the digital image to identify, in the data comprising the digital image, information identifying a patient of the healthcare provider, a transaction of the patient with the healthcare provider, an insurance policy covering at least a portion of one or more expenditures of the healthcare provider associated with the transaction of the patient with the healthcare provider, and one or more amounts of the one or more expenditures of the healthcare provider associated with the transaction of the patient with the healthcare provider covered by the insurance policy.

14. The method of claim 13, wherein generating the data for the one or more graphical user interfaces comprises generating data for one or more graphical user interfaces configured to provide, for each digital image of the portion of the plurality of digital images corresponding to the explanation-of-benefits documents, the healthcare provider with the information identifying the patient of the healthcare provider, the transaction of the patient with the healthcare provider, the insurance policy covering the at least a portion of the one or more expenditures of the healthcare provider associated with the transaction of the patient with the healthcare provider, and the one or more amounts of the one or more expenditures of the healthcare provider associated with the transaction of the patient with the healthcare provider covered by the insurance policy.

15. The method of claim 1, comprising:
receiving, via the communication interface, data comprising a different plurality of digital images, the different plurality of digital images being associated with a different healthcare provider, each digital image of the different plurality of digital images comprising an image of at least a portion of one or more physical documents of a plurality of physical documents associated with the different healthcare provider and retrieved from a secure, physical drop-box associated with the different healthcare provider;
identifying, by the at least one processor, a portion of the different plurality of digital images corresponding to financial instruments physically deposited in the physical drop-box associated with the different healthcare provider, a portion of the different plurality of digital images corresponding to explanation-of-benefits documents physically deposited in the physical drop-box associated with the different healthcare provider, and a portion of the different plurality of digital images corresponding to other documents physically deposited in the physical drop-box associated with the different healthcare provider, the other documents physically deposited in the physical drop-box associated with the different healthcare provider comprising neither the financial instruments physically deposited in the physical drop-box associated with the different healthcare provider nor the explanation-of-benefits documents physically deposited in the physical drop-box associated with the different healthcare provider;
classifying, by the at least one processor and in accordance with a set of classification rules associated with the different healthcare provider and stored in the memory, each digital image of the portion of the different plurality of digital images corresponding to the other documents into a category of a plurality of different categories specified by the set of classification rules associated with the different healthcare provider;
generating, by the at least one processor, data for at least one graphical user interface configured to provide the different healthcare provider with access to each digital image of the portion of the different plurality of digital images corresponding to the other documents and comprising one or more elements distinguishing each digital image of the portion of the different plurality of digital images corresponding to the other documents classified into a particular category of the plurality of different categories specified by the set of classification rules associated with the different healthcare provider from each other digital image of the portion of the different plurality of digital images corresponding to the other documents classified into a category of the plurality of different categories specified by the set of classification rules associated with the different healthcare provider different from the particular category of the plurality of different categories specified by the set of classification rules associated with the different healthcare provider; and
communicating, via the communication interface and to a computing device associated with the different healthcare provider, the data for the at least one graphical user interface.

16. The method of claim 1, wherein the plurality of different categories comprises at least one of a category for patient correspondence or a category for returned mail, and wherein classifying each digital image of the portion of the plurality of digital images corresponding to the other documents comprises classifying at least one digital image of the portion of the plurality of digital images corresponding to the other documents into at least one of the category for patient correspondence or the category for returned mail.

17. The method of claim 1, wherein the plurality of different categories comprises at least one of a category for attorney requests, a category for charitable requests, or a category for government-healthcare-program documents, and wherein classifying each digital image of the portion of the plurality of digital images corresponding to the other documents comprises classifying at least one digital image of the portion of the plurality of digital images corresponding to the other documents into at least one of the category for attorney requests, the category for charitable requests, or the category for government-healthcare-program documents.

18. The method of claim 1, wherein the plurality of different categories comprises a category for insurance documents that require a response from the healthcare provider and a category for insurance documents that do not require a response from the healthcare provider, and wherein classifying each digital image of the portion of the plurality of digital images corresponding to the other documents comprises:
classifying at least one digital image of the portion of the plurality of digital images corresponding to the other documents into the category for insurance documents that require a response from the healthcare provider; and
classifying at least one digital image of the portion of the plurality of digital images corresponding to the other documents into the category for insurance documents that do not require a response from the healthcare provider.

19. A system, comprising:
one or more document-imaging devices configured to generate a plurality of digital images, each digital image of the plurality of digital images comprising an image of at least a portion of one or more physical documents associated with a healthcare provider;
at least one processor; and
a memory storing instructions that when executed by the at least one processor cause the system to:
identify, from amongst the plurality of digital images, a group of digital images comprising images of physical financial instruments, a group of digital images comprising images of physical explanation-of-benefits documents, and a group of digital images comprising images of physical documents that are neither financial instruments nor explanation-of-benefits documents; and
classify each digital image in the group of digital images comprising images of physical documents that are neither financial instruments nor explanation-of-benefits documents into a category of a plurality of predetermined categories identified by the healthcare provider.

20. One or more non-transitory computer-readable media having instructions stored thereon that when executed by one or more computers cause the one or more computers to classify, in accordance with a set of classification rules associated with a healthcare provider, each digital image of a plurality of digital images comprising images of physical documents associated with the healthcare provider that are neither financial instruments nor explanation-of-benefits documents into a category of a plurality of different categories specified by the set of classification rules.
